(19) United States
(12) Patent Application Publication
(10) Pub. No.: US 2006/0178178 A1
(43) Pub. Date: Aug. 10, 2006

(54) Device for inputting control signals for a computer-based simulated table football game

(75) Inventors: Bernhard Nebel, Schallstadt (DE); Weigel Thilo, Freiburg (DE)

Correspondence Address: Orum & Roth, Suite 1616, 53 West Jackson Boulevard, Chicago, IL, 60604, US

(73) Assignee: ALBERT-LUDWIGS-UNIVERSITAT FREIBURG, Freiburg (DE)

(21) Appl. No.: 10/562,375

(22) PCT Filed: Jun. 21, 2004
(86) PCT No.: PCT/DE04/01278

§ 371 Date: Feb. 28, 2006

(30) Foreign Application Priority Data
Jun. 27, 2003 (DE) 103 29 181.4

(51) Int. Cl. A63F 13/00

(52) U.S. Cl. 463/4; 463/37

(57) ABSTRACT

The invention relates to a device for inputting control signals into a computer for a computer-based simulated table football game. Said device comprises a housing (1) and rods (2) that are mounted on said housing in a rotatable and displaceable manner. Each rod (2) is provided with two sensors (7, 8) for detecting absolute positions in relation to the translation and rotation of the rod. An interface is used for the transmission of the data from the sensors to the computer.

The invention relates to a device for inputting control signals for a computer-based simulated table soccer game according to the pre-characterizing part of Claim 1.

In a purely mechanical soccer table, two teams are provided having, for example, eleven playing figures per team. The playing figures of each team are normally arranged in four rows: one goalie, two defenders, five midfielders, and three attackers. All the players in each row are arranged on a slidable and rotatable rod. This means that each rod has two degrees of freedom. The rods can be used to move the players and play the ball. These kinds of table soccer games are also known as foosball tables.

Computer-based simulated table soccer games are known from the prior art, in which the playing field, the players, and the ball are displayed on a screen. As in a purely mechanical soccer table, the players are arranged in rows. The associated rods can also be displayed on the screen. In order to slide and rotate the displayed rows, control data is entered via a computer mouse, a standard computer keyboard, a joystick, or a standard controller for games consoles. It is possible either for two users to play against each other or for just one user to play against the computer. Although these computer-based table soccer games can be played on almost any personal computer, they are difficult to operate. There is a fundamental difference between operating a keyboard and operating the rods of a purely mechanical soccer table. It is not possible to use a computer keyboard or a computer mouse to execute the rotating and sliding movements of the rods of a mechanical foosball table, which means that it is not possible to achieve a genuine simulation. A further disadvantage is the fact that, in order to move the four rows of players that make up a team, it is either necessary to constantly switch to the keyboard or to use a multitude of keys, which are not easy for the user to remember. In simpler computer-based table soccer games, operation of the keyboard or mouse moves all the rows simultaneously, which avoids the necessity of switching controls. The disadvantage of this method is that it has hardly any features in common with a table soccer game played on a purely mechanical soccer table.

Furthermore, computer-based simulated table soccer games are known, which are not based on simulating the rotatable and slidable rods of a foosball table. Items such as knobs or buttons, for example, are provided to enable the user to manually control the playing figures, though they generally only allow for displacement of the figures in parallel to the playing field. It is necessary to operate the button several times until the playing figure reaches the desired position. If a playing figure and the ball should come into contact, then the ball would bounce off the figure in a manner determined by the specific software used. In these kinds of soccer game simulations, it is not possible for the ball to be kicked or hit by a playing figure with a force input by the user or with a torsional force.

In contrast, the device according to the invention with the features of Claim 1 has the advantage that the control data is input in an identical fashion to how the rows of a purely mechanical soccer table are moved. Rods are provided in the housing either for each row of a team or for each row of both teams. They are mounted in the housing in a slidable and rotatable arrangement, whereby the translation is effected in an axial direction, and the rotation is effected around the rods' axes.

As in the case of a mechanical foosball table, the degree of travel is restricted by limiting devices on the rods. The limiting devices may comprise rings or disks on the rods either inside or outside the housing. The travel of the different rods may vary. For example, it may only be possible to move the goalie along a path of travel in front of the goal, as in a mechanical foosball table. The travel of the rods assigned to the defenders or the attackers may be greater than that of the midfielders. The distance of travel is either identical to that of mechanical foosball tables or slightly shorter. It is selected, however, so that the operation of the rods is comparable to the operation of mechanical foosball tables.

Two or more bearings are arranged on the housing for each of the rods. The rods can be rotated around their own axes by 360° or more, with no stopper or block. As in the case of a mechanical foosball table, the rotation is not restricted.

Two sensors are provided on each rod, which record the rods' translation and rotation. The sensors determine the absolute position of the rod in relation to a defined zero point by continuously scanning the rod or a transmitter on the rod by means of a mechanical contact connection or a non-contact method. The absolute position of a rod is composed of an angle of rotation and a displacement. Both values relate to the defined zero point. The electric signals conforming to the positions are forwarded to the computer via the interface. The corresponding position of the foosball table's playing figures is then shown on a display unit, for example, a computer monitor. In contrast to known computer-based simulated soccer games, in which a button or a knob must be operated multiple times to move the playing figures, the device according to the invention enables the movement of a rod to be converted into an identical movement of the playing figures assigned to the rod on the display unit. Appropriate software is provided for this purpose. This means that the simulation of the foosball table comes very close to the reality of a mechanical foosball table. What a player feels when operating the rods is no different from what the player feels when playing on a real foosball table. Thus, the player can identify the position of the playing figures from the position of the rods, in particular, from the set degree of displacement, even without looking at the display unit.

The sensors allow the absolute position of the rods in relation to a defined zero point to be determined at any time. Depending on the type of sensors, measurement is made either of the absolute value in relation to the zero point, or of the relative displacement between an initial position and a final position. In the former case, the position of the rod follows directly from the measurement, though it may still be necessary to convert the measured value, for example, the electric current, into a distance or angle. In the latter case, the absolute position of the rod is calculated from the relative displacement and the initial position. This calculation can either be made by the computer, to which the device is connected, or the device can be provided with a separate computer for this purpose.

Where necessary, the speed and acceleration can be calculated from the various positions by calculating the first and second time derivatives. It is also possible to provide special sensors to determine the speed and/or the acceleration.

The depiction of the playing figures and the ball shown on the display unit of the computer, to which the device is connected, can be either two-dimensional or three-dimensional. This depends on the software. The control device according to the invention supports both three-dimensional and two-dimensional depictions.

The device according to the invention allows both two users to play against each other and a single user to play against a computer-controlled opponent. In a device for two users, a corresponding number of rods is provided. These may be housed either in just one housing or in two housings. If only one user is playing against the computer, then half the number of rods will suffice. It is also possible to link two devices intended for a single user either together or with a computer in a manner that allows two users to play against each other.

In the case of two players playing against each other, they can also be physically separated. The data entered in a computer via the device according to the invention can also be transmitted to other computers via a computer network. If data exchange is carried out over a computer network, then it is possible for the two users playing against each other to be located in different places.

Normally, a table soccer game involves four rows of playing figures and, hence, four rods being provided for each team. This number, however, may vary. The device can therefore be equipped with correspondingly more or fewer rods.

The device according to the invention can be fabricated as a low-cost product. It is suited to both private use and use in publicly accessible video arcades and bars and, therefore, can be marketed to the home PC market and to commercial users.

According to a preferred embodiment of the invention, the rods of a team are arranged next to each other and parallel to each other. The ends of the rods, which are provided with handgrips, protrude from one side of the housing. If necessary, the rods can be removed from the housing or dismantled into smaller pieces when the device is not being used. Rods with a telescopic design are also suited to this purpose.

Devices according to the invention that enable two users to play against each other also feature rods arranged next to and in parallel with each other, the ends of which protrude from the two opposing sides of a housing.

According to a further preferred embodiment of the invention, a brake is provided on the rods to retard or block the rotation of a rod in a direction. The brake is connected to the computer via an interface, in order that the brake can be triggered by the computer whenever a certain situation arises in the table soccer simulation. Such a situation arises whenever the ball becomes lodged between a playing figure and the playing field. In the event of such a situation on a mechanical foosball table, the user is only able to rotate the rod corresponding to the playing figures in one direction. The rod is blocked in the other direction of rotation, though it is still possible to slide the rod. In order to provide users with a haptic simulation of this situation in the device, according to the invention, the brake is triggered by the computer. The rotation of the rod in one direction is retarded or completely blocked by means of a mechanical contact connection on the rod, such as engagement with the gear unit, for example, or by means of a non-contact method through the creation of a magnetic field that repels a permanent magnet arranged on the rod. The brake is released once the situation no longer applies. This method can also be used to provide users with haptic transmission of the kicking of the ball by a playing figure. In this case, however, the brake acts upon the rod with a far weaker force, so that the user only senses a slight force acting against the torque exerted by him on the rod. This kind of resistance also arises when playing the ball on a mechanical foosball table.

According to a preferred embodiment of the invention, potentiometers are employed as sensors. Gear units are provided on the rods to actuate the potentiometers. The gear units may consist of a gear rack and toothed wheels, for example. In the event of the rod rotating or sliding, the potentiometers are actuated, and the resistance of the potentiometers changes. In this way, under constant voltage, the electric current changes. This current is forwarded to the computer. Since every setting of a potentiometer corresponds to an absolute resistance and thus an absolute current, the coordinates of the rods corresponding to the resistance values are defined as absolute values and can be determined. The absolute values relate to a defined zero point.

According to a further preferred embodiment of the invention, optical distance measuring devices are provided on the housing as sensors. Transmitting devices are arranged on the rods to actuate the distance measuring devices. For the sensor for translation, a disk can be provided on the rod vertical to the rod's axis, for example. For the sensor for rotation, the rod can be provided with a disk, which features a pattern, for example, a barcode. Another possibility is to provide a disk inclined toward the rod's axis or positioned off-center from the rod's axis. As the rod rotates, either the disk's pattern changes or the distance changes between the fixed optical distance measuring device and a defined measurement area on the disk. From the scanned pattern or the measured distance, it is possible to derive the angle of rotation.

The optical or mechanical elements known from computer mice are also suited to use as sensors for determining the position of the rods. This involves the use of elements, such as balls or wheels, or optical determination of the distance covered. In contrast to their use in a computer mouse, the sensors are fixed, while the rod is moved in relation to the sensors. Nevertheless, the principle is based on a relative movement between the sensor and the underlying surface or rod, respectively, and therefore is also applicable in this context. Since this involves determining the relative travel, it is necessary to calibrate this to a defined zero point in order to determine the absolute position of the rods. This may be carried out automatically upon switching on the device.

The rods of the device according to the invention may be composed of plastic, metal, or a composite, for example. The end operated by the user is advantageously provided with a handgrip.

Further advantages and advantageous embodiments of the invention are to be drawn from the claims.

### DRAWING

The drawing features an example embodiment of the invention. It shows the following:

FIG. 1 Perspective view of a device for inputting control signals for a computer-based simulated table soccer game

FIG. 2 Top view of the device for inputting control signals shown in FIG. 1 with the housing open

FIG. 3 Section of the device shown in FIG. 2 at the point marked A-A in FIG. 2

FIG. 4 Display of the simulated soccer table on a screen

### DESCRIPTION OF THE EXAMPLE EMBODIMENT

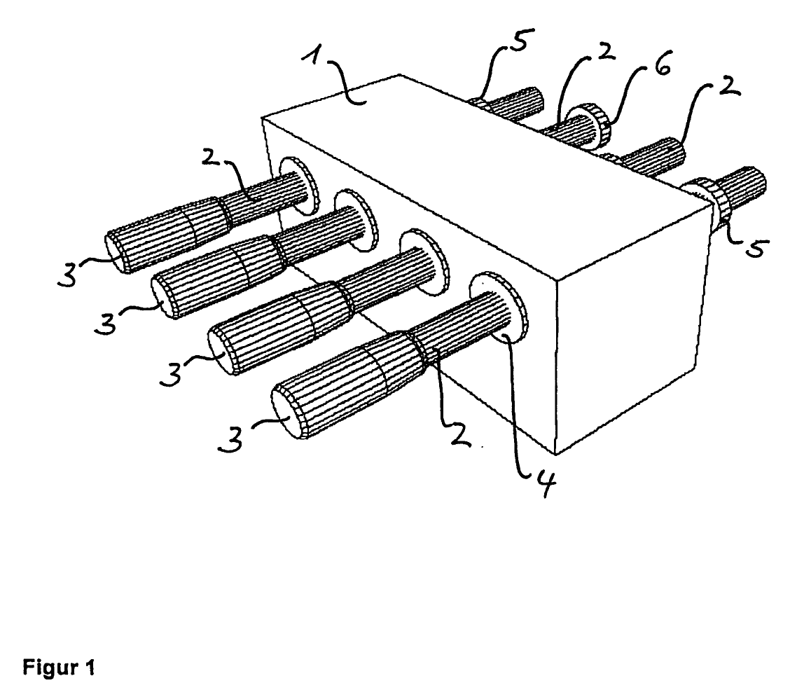

FIG. 1 shows a perspective view of a device for inputting control signals for a computer-based simulated table soccer game. In housing 1, four rods 2 are mounted in a slidable and rotatable arrangement. The ends of the rods, which are operated by a user, who is not shown in the drawing, are provided with handgrip 3. Rods 2 and handgrips 3 have a circular cross-section. For ease of operation, handgrips 3 have a larger diameter than rods 2.

Rods 2 pass through housing 1 in such a way that both ends of rods 2 protrude from housing 1. The walls of housing 1 feature openings for rods 2. The openings are provided with a bearing 4 for rods 2. Bearings 4 are used to ensure that rods 2 are easy to slide and rotate. For this purpose, balls or rollers, for example, can be provided in the bearings, on which the rods roll or slide. The balls or rollers are not visible in the drawing. Instead of an additional bearing, it is also possible to simply provide openings in the walls of the housing, the cross-section of which is just slightly larger than the cross-section of the rods. This provides the rods with enough clearance to be able to slide and rotate.

To restrict the amount of travel, each rod 2 is provided with disks 5 and 6. The travel is thereby limited by handgrip 3 at one end of rod 2 and by disk 5 at the other end of rod 2. The distance between handgrip 3 and disk 5 on a rod 2 depends on the row to which the rod is assigned. For example, the goalie's row has a different amount of travel to the defenders' row. For this reason, disk 6 is located right at the end of one of rods 2, while, in the case of other rods, it is positioned at a distance from the end of the rod.

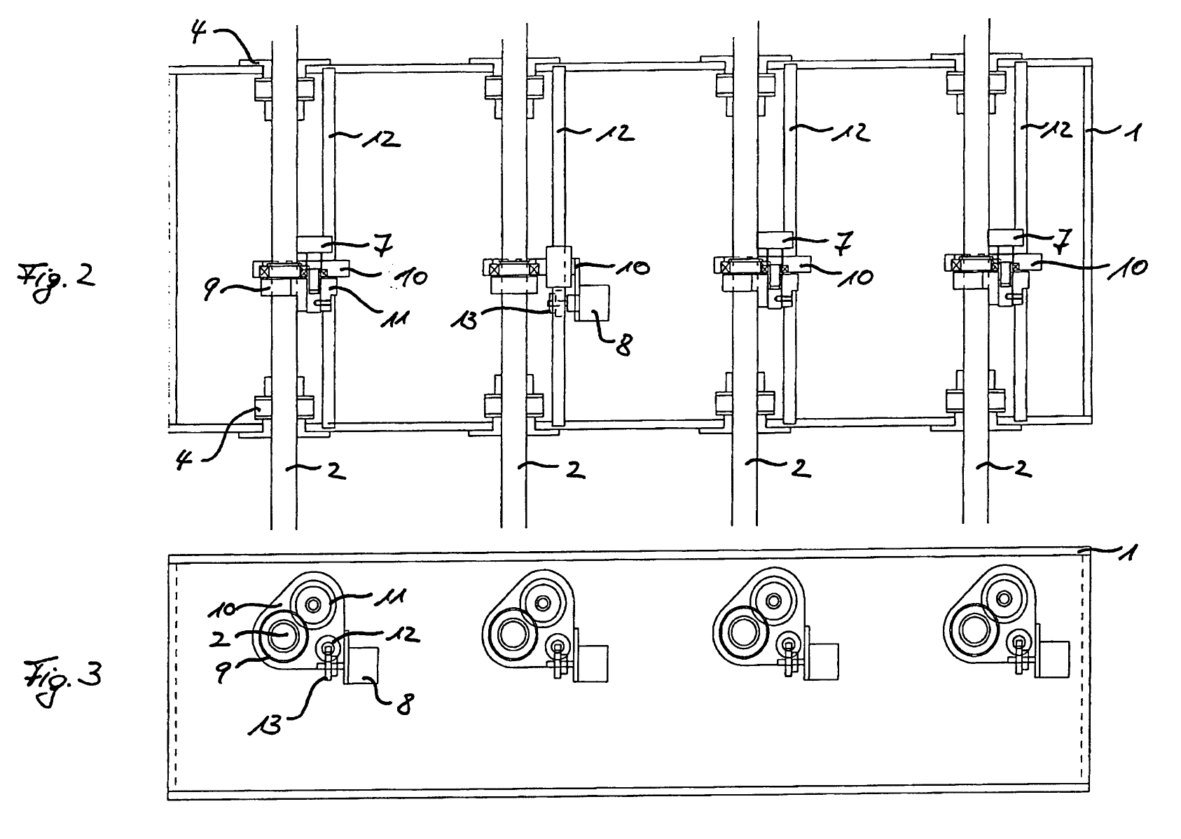

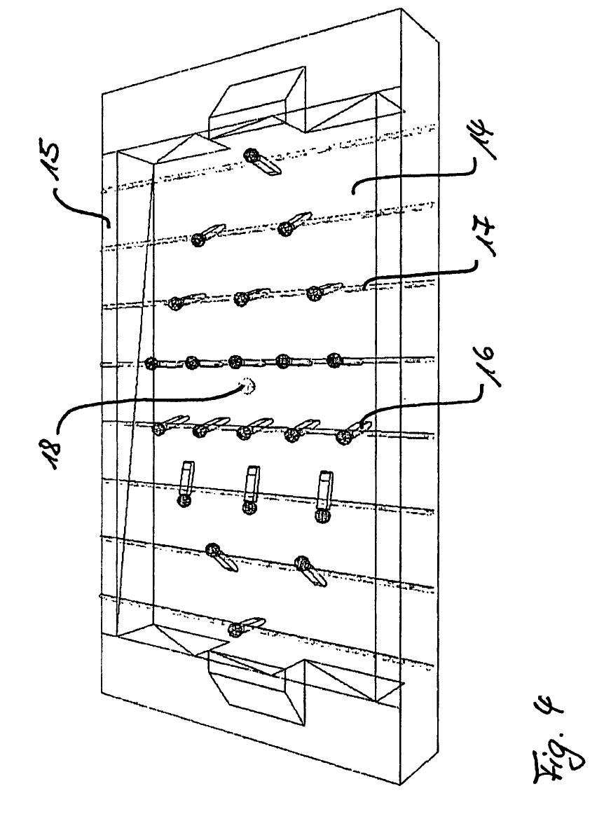

FIGS. 2 and 3 feature a top view and a side view with opened housing 1 of the devices shown in FIG. 1. Rods 2 and bearings 4 can be seen in this view. Furthermore, the view shows potentiometers 7 and 8 and a gear unit to transmit the translation and rotation of rods 2 to potentiometers 7 and 8. All four rods are fitted with the same gear unit and the same potentiometers 7 and 8. For the purposes of simplified depiction, however, only the second rod from the left in FIG. 2 shows potentiometer 8 used to determine the translation of the rods, while the remaining three rods only show potentiometer 7 used to determine the rotation of the rods. In FIG. 3, all four gear units are depicted in an identical fashion.

The gear units essentially consist of a rack and toothed wheels. To transmit the rotary motion of a rod to potentiometer 7, toothed wheel 9 is provided on rods 2. Potentiometer 7 is attached to carriage 10. In turn, this is connected to toothed wheel 11, which engages with toothed wheel 9. A rotary motion of rod 2 is thereby transmitted to potentiometer 7 via toothed wheels 9 and 11.

To transmit the translatory motion of rods 2 to potentiometer 8, gear racks 12 are attached to the housing. These run parallel to rods 2. Potentiometer 8 is attached to carriage 10. With toothed wheel 13, it engages with gear rack 12. When rod 2 is displaced through sliding, potentiometer 8 is displaced relative to rack 12, whereby potentiometer 8 is actuated through toothed wheel 13 that rolls over rack 12.

FIG. 4 shows a display of the foosball table on a screen. The display shown in the figure is a three-dimensional display. The screen shows playing field 14 with playing field boundary 15, playing FIGS. 16 with corresponding rods 17, and ball 18. All of the features of the invention may be key elements of the invention both individually and in any combination with each other.

### LIST OF REFERENCE NUMBERS

1 Housing
2 Rod
3 Handgrip
4 Bearing
5 Disk
6 Disk
7 Potentiometer
8 Potentiometer
9 Toothed wheel
10 Carriage
11 Toothed wheel
12 Rack
13 Toothed wheel
14 Playing field
15 Playing field boundary
16 Playing figure
17 Rod
18 Ball

1. Device for inputting control signals to a computer, which is provided with a display unit to display a playing field for playing figures arranged in several parallel rows and a ball forming part of a computer-based simulated table soccer game,
having a housing,
having multiple rods in the housing which are mounted so as to be slidable in an axial direction and rotatable around their own axes by at least 360°,
having at least two bearings or openings in the housing for each of the rods,
having devices to limit travel attached to the rods,
having a sensor on each rod to determine translation, which continuously determines the position of the rod in an axial direction by means of a mechanical contact connection or a non-contact method,
having a sensor on each rod to determine rotation, which continuously determines the angle of rotation of the rod with regard to rotation around its own axis by means of a mechanical contact connection or a non-contact method, and having an interface to transfer the data received by the sensors to a computer.

2. Device according to claim 1, wherein a rod is provided for each of the rows of a team of the table soccer game displayed on the display unit.

3. Device according to claim 1, wherein four rods are positioned next to each other and parallel to each other in the housing, the ends of which protrude from at least one side of the housing.

4. Device according to claim 1, wherein eight rods are positioned next to each other and parallel to each other in the housing, whereby the ends of four rods facing a first user protrude from one side of the housing, and the ends of four further rods facing a second user protrude from the opposite side of the housing.

5. Device according to claim 1, wherein a brake is provided on the rods to retard or block the rotation of a rod in a direction, and the brake is connected to the computer via an interface, in order that the brake can be actuated by the computer whenever a certain situation arises in the simulated table soccer game.

6. Device according to claim 1, wherein the sensors provided comprise optical, mechanical, magnetic, inductive, or electric sensors.

7. Device according to claim 1, wherein potentiometers are provided as sensors.

8. Device according to claim 7, wherein a gear unit is provided on the rods to actuate the potentiometer.

9. Device according to claim 8, wherein a first toothed wheel is provided on the rod and a second toothed wheel, which engages with the first toothed wheel, is provided on the potentiometer used to determine the rotation.

10. Device according to claim 8, wherein a carriage is positioned on the rod, wherein the potentiometers equipped with a toothed wheel used to determine translation is attached to the carriage, and wherein a non-displaceable gear racks is provided on the housing parallel to the rod, whereby the toothed wheel engages with the gear rack.

11. Device according to claim 9, wherein the potentiometer used to determine rotation is attached to the carriage.

12. Device according to claim 1, wherein at least one optical distance measuring device is provided on the housing as a sensor used to determine translation, and a transmitting device to trigger the distance measurement is provided on the corresponding rod or a part of the rod serves as a transmitting device.

13. Device according to claim 12, wherein a disk is provided on the rods, which is provided with a pattern, and wherein at least one optical sensor used to scan the pattern on the disc is provided on the housing as a sensor used to determine the rotation of the rod.

14. Device according to claim 12, wherein at least one distance measuring device is provided on the housing as a sensor used to determine the rotation of a rod, and wherein a disk is arranged on the corresponding rod either inclined toward the rod's axis at an angle other than 90° or positioned off-center from the rod's axis.

15. Device according to claim 1, wherein the sensor features a freely-rotating trackball adjacent to the rod, wherein two rollers are provided, which are positioned adjacent to the trackball and which measure the trackball's movements, wherein perforated disks are provided on the rollers, and wherein light-emitting diodes and sensors are provided on the perforated disks to detect the pulses of light from the light-emitting diodes that pass through the holes of the perforated disks.

16. Device according to claim 1, wherein the sensors feature at least one light source, and at least one optical sensor is provided, which picks up the light reflected from the rod.

17. Device according to claim 16, wherein a bar pattern is provided on the rod.

18. Device according to claim 2, wherein four rods are arranged next to each other and parallel to each other in the housing, the ends of which protrude from at least one side of the housing.

19. Device according to claim 2, wherein eight rods are arranged next to each other and parallel to each other in the housing, whereby the ends of four rods facing a first user protrude from one side of the housing and the ends of four further rods facing a second user protrude from the opposite side of the housing.

20. Device according to claim 2, wherein a brake is provided on the rods to retard or block the rotation of a rod in a direction, and the brake is connected to the computer via an interface, in order that the brake can be actuated by the computer whenever a certain situation arises in the simulated table soccer game.
